(19) United States
(12) Patent Application Publication
(10) Pub. No.: US 2008/0260612 A1
(43) Pub. Date: Oct. 23, 2008

(54) Oxidation of metallic materials as part of an extraction, purification and/or refining process

(75) Inventor: Lawrence F. McHugh, North Andover, MA (US)

Correspondence Address: BURNS & LEVINSON, LLP, 125 SUMMER STREET, BOSTON, MA, 02110, US

(73) Assignee: Orchard Material Technology, LLC, North Andover, MA (US)

(21) Appl. No.: 12/148,397

(22) Filed: Apr. 18, 2008

Related U.S. Application Data
(60) Provisional application No. 60/912,550, filed on Apr. 18, 2007.

(51) Int. Cl. C01F 15/00; C01D 1/02; C01F 5/00; C01G 53/04; C01G 51/04; C01G 49/02; C01F 7/02; C01G 15/00; C01G 9/02; C01G 21/02; C01G 19/02; C01G 27/00; C01G 23/04; C01G 39/00; C01G 45/02; C01G 47/00; C01G 3/02; C01G 5/00; C01G 43/01; C01G 31/02; C01F 17/00

(52) U.S. Cl. 423/252; 423/592.1; 423/642; 423/643; 423/637; 423/638; 423/639; 423/594.19; 423/632; 423/630; 423/631; 423/625; 423/624; 423/622; 423/619; 423/618; 423/617; 423/608; 423/607; 423/606; 423/605; 423/604; 423/594.17; 423/263; 423/260

(57) ABSTRACT

Multi-step metal compound oxidation process to produce compounds and enhanced metal oxides from various source materials, e.g. metal sulfides, carbides, nitrides and other metal containing materials with metal oxides from secondary reaction steps being utilized as an oxidation agent in the first reactions.

### FIELD AND BACKGROUND OF THE INVENTION

The present invention relates to processes for removal and capture of impurities from metal ores, recycled materials and compounds as part of the extraction, purification and/or refining processes.

The object of the present invention is to provide an improvement in metal extraction processes (and the like) focused on effective realization of target metal compounds, oxides and sub-oxides and the efficient removal of unwanted materials in an energy efficient manner. Materials of adequate purity are to be achieved while reducing overall processing costs, improving the efficiency of environmental protection and allowing for additional energy recovery.

Many metal ores and recovered materials have large portions of metal compounds in the form of sulfides, carbides, hydrides, nitrides and other compound forms that require oxidation purification. Typical processing methods primarily targeting the refining and recovery of metal values from sulfide ores, as an example, may involve mechanical sizing of ores, froth flotation, electro-winnowing, solvent extraction, smelting, roasting, electro-refining, slow oxidation processes assisted by microorganisms, pressure oxidation, digestion of the ores or compounds in acid and molten salt fusion. Other metal and mineral recovery processes produce carbides, hydrides, nitrides, and mixed organic complex materials also requiring oxidation purification. Recovery of merchantable sulfur, carbon, and hydrogen containing by-product compounds can be an important benefit of such processes.

It is disclosed in U.S. Pat. No. 4,552,749 to oxidize metal sulfide materials to sub-oxides. In the referenced patent MoS.sub.2 is oxidized to MoO.sub.2 by reacting it with MoO.sub.3. Finely divided MoO.sub.3 and MoS.sub.2 are mixed together in the ratio of about seven or more moles of MoO.sub.3 to one mole of MoS.sub.2. This mixture is then heated to 600.degree. C.-700.degree. C. in a closed chamber where SO.sub.2 is evolved. The MoO.sub.2 product is then desulfurized at 400.degree. C.-600.degree. C. in an atmosphere containing 10 wgt. % or less SO.sub.2 and thereafter cooled in a neutral or reducing atmosphere to 250.degree. C. A portion of the MoO.sub.2 is removed from the reactor as a product and the remainder is selectively oxidized at a temperature sufficient to generate gaseous MoO.sub.3 which is recycled to the reactor relative to the flow of MoS.sub.2 therein to convert the MoS.sub.2 to MoO.sub.2. Although this method was employed to produce MoO.sub.2 the process could not be carried out in a continuous manner because the second step of the reaction resulted in the sublimation of the MoO.sub.3 in the case of flash reactors or sintering and balling problems in the case that kilns, multiple hearth furnaces or other furnace devices were employed. These sublimation, sintering, and balling problems have made it impractical to effectively recycle the MoO.sub.3 to the first reactor without the need for consolidation and densification or milling and blending operations. These physical handling steps eliminated the ability of the process to operate in a continuous manner and for maximum energy efficiency. Other methods for producing MoO.sub.2 have involved reducing MoO.sub.3 with H.sub.2, NH.sub.3 or carbon and these also have limits of effectiveness.

One other embodiment for producing MoO.sub.2 by reacting MoO.sub.3 with MoS.sub.2 is disclosed in U.S. Pat. No. 3,336,100. The process as claimed comprises mixing MoO.sub.3 with MoS.sub.2 to provide a uniform mixture containing substantially stoichiometric amounts of the reactants. The mixture is reacted at a temperature between 600.degree. C. and 700.degree. C. in a closed chamber to evolve SO.sub.2. The pressure in the chamber is maintained at slightly above atmospheric pressure to prevent air from entering the chamber and form a product having a low sulfuric content. The desulfurization is carried out in an atmosphere containing less than 10 wgt. % SO.sub.2 and at a temperature substantially between 400.degree. C. and 600.degree. C. to obtain MoO.sub.2. Following the reaction, the molybdenum dioxide (MoO.sub.2) is cooled at least to 250.degree. C. under either a neutral or a reducing atmosphere.

Reducing MoO.sub.3 with H.sub.2 or NH.sub.3 is very expensive and reactions with solid reductants usually produce an impure product. Reacting MoS.sub.2 and MoO.sub.3 at 600.degree. C.-700.degree. C. is a slow reaction which requires two hours or longer and which results in a product which must be treated to desulfirize to an acceptable sulfur value. It also requires several furnaces for the different SO.sub.2 levels which are maintained in the gas. Another disadvantage is that a 25% or more stoichiometric excess of MoO.sub.3 must be used in order to obtain a low sulfur product. Thus the product is generally not MoO.sub.2 per se but a mixture of MoO.sub.2 and MoO.sub.3.

The present invention recognizes and fills a need for a process for producing metallic sub-oxides from metallic sulfides, carbides, hydrides, nitrides and other compound forms which is fast, efficient and allows for a continuous recycle of the fully oxidized product of the second reactor wherein that second reactor product exhibits good density and fine particle size structure and which provides a second reactor product which is low in sulfur and can be recycled to the first reactor as an effective oxidizing agent for the first reactor. It would further be desirable if said second reactor product could be recycled to the first reactor at temperature thus providing the system with greatly

### SUMMARY OF THE INVENTION

As applied to sulfides (and extendable to metal extraction for other metal compounds), the above stated object of the invention is achieved by a two-step looping sulfide oxidation process. The process separates the (inorganic or organic) sulfide oxidation process into at least two reaction steps. In the first step a main metal oxidation process is conducted reacting the sulfide (e.g. metal sulfide) with an oxide solely or primarily derived from the starting material or supplemented by a make-up oxidizer from an external source, or an oxide of another material of desired material content to produce a metallic compound or a metal sub-oxide and, in a subsequent step or steps, the compound or sub-oxide material, as produced in the first step, is further oxidized raising the sub-oxide to a higher oxidation level. All or part of the oxide produced in the second step can be recycled to the first step as a sole or primary oxidizing agent but ultimately can be recovered. The present invention may be applied with particular benefit to the sulfides of the metals: Ag, Ni, Fe, Co, Cu, Zn, Sn, Pb, and mixed sulfide minerals of the following materials: FeNi, NiCo, PbZn and FeCu (chalcopyrite). This process can be further extended and tailored to process inorganic sulfides, organo-sulfides, inorganic sulfates, organo-sulfates, inorganic carbides, inorganic carbonates and organo-carbonates. Two illustrative cases, for metal sulfides, are as follows:

### Case A

Step 1: MS_{z}+MOₓ→MO_{y}+SO_{w} (M is a metal, S is sulfur, O is oxygen)
Step 2: MO_{y}+O₂→MOₓ (recycled to step 1 as the oxidizing agent)

### Case B

Step 1: M1S_{z}+M1Oᵥ+M2Oₓ→M1Oᵤ+M2O_{y}+SO_{w} (M1 is a first metal, M2 is a second metal)
Step 2: M1Oᵤ+M2O_{y}+O₂→M1Oᵥ+M2Oₓ (M1Oᵥ and M2Oₓ are recycled as the oxidizer for step 1). The metals M, M1, M2 may be single elements or alloyed or mixed elements.

In the example of a metal sulfide ore or derivative (or recycled product) the material can thus be processed in a two step oxidation process that yields a metal sub-oxide and a high concentration sulfur oxide gas stream. Then, in the second step, the sub-oxide is further oxidized to at least a higher oxidation state, preferably to fully oxidized stoichiometry, to efficiently generate energy and an oxide that can be recycled to the first reactor as the oxidizing agent for the first step of the process. Major improvements in the process embodiment have been achieved through a dilute reactant oxidation process as applied to this reaction step. Through dilute reactant processing the sub-oxide to be processed is fed to the second reactor while the second reactor is more than 50% filled with the more fully oxidized product. In this way the reacting sub-oxide is diluted to the point that sublimation can be controlled and sintering and balling is eliminated. It is also possible to expand this process concept to multiple steps of partial oxidation which can allow for the production of commercially interesting intermediate sulfates, carbonates, nitrates, sub-oxides, and combinations of these compounds.

In the example of sulfide ores, the first step efficiently removes sulfur materials in a concentrated manner as sulfur oxide for recovery, use, or for further reaction to produce sulfur, sulfates or other derivatives. In the second step of the process the second oxidation can be carried out in a way that maximizes oxidation kinetics and energy recovery. Since environmentally harmful impurities can be removed in the first step reaction, the second oxidation can be carried out in a way that no sulfur, carbon, or nitrogen containing gases are produced which allows for aggressive energy recovery and minimal environmental costs. The second step reforms the oxidizing agent used in the first reaction.

The separation allows a two step process that efficiently removes unwanted chemicals and environmentally damaging chemicals in the first step. Then in the second step the material can be further oxidized without a contaminated off-gas stream allowing for ease of processing and maximum energy recovery.

The foregoing process can be applied similarly to other chemical families, e.g. carbides, carbonates, hydrides, nitrides and nitrate, organic containing mixtures or compounds containing these materials and materials found separately from or in combination with metal containing materials. The process can also be used in recycling tailings, previously used chemicals, catalysts, carbides, nitrides, organic metal complex materials or mixed waste products.

Other objects, features and advantages will be apparent from the following detailed description of preferred embodiments taken in conjunction with the accompanying drawing in which:

### BRIEF DESCRIPTION OF THE DRAWING

FIG. 1 is a block diagram of the first process step in practice of the invention as applied to metallic compounds;

FIG. 2 is a block diagram of the second process step as applied to metallic compounds which further oxidizes the intermediate metallic oxide in a dilute reactant system to a higher oxidation state under effective temperature control to be recycled to the first process step as the oxidizing agent for the first reaction;

FIG. 3 is a block diagram of the combined reaction steps in practice of the invention as applied to metallic compounds. In these reaction steps a metallic compound of a highly oxidized state is combined with a metallic compound of a more reduced state wherein these reactants are raised in temperature until the reaction proceeds to completion producing a metallic compound of an intermediate oxidation state and an oxidized off gas; and

FIG. 4 is a block diagram of the combined reaction steps in practice of the invention as applied to metallic compounds. In these reaction steps a plurality of metallic compounds of a highly oxidized state are combined with metallic compounds of a more reduced state wherein these reactants are raised in temperature until the reaction proceeds to completion producing a plurality of metallic compounds of an intermediate oxidation state and an oxidized off gas. The metallic sub-oxides are further oxidized in a dilute reactant system to a higher oxidation state under effective temperature control to be recycled to the first process step as the oxidizing agents for the first reaction.

### DETAILED DESCRIPTION OF PREFERRED EMBODIMENTS

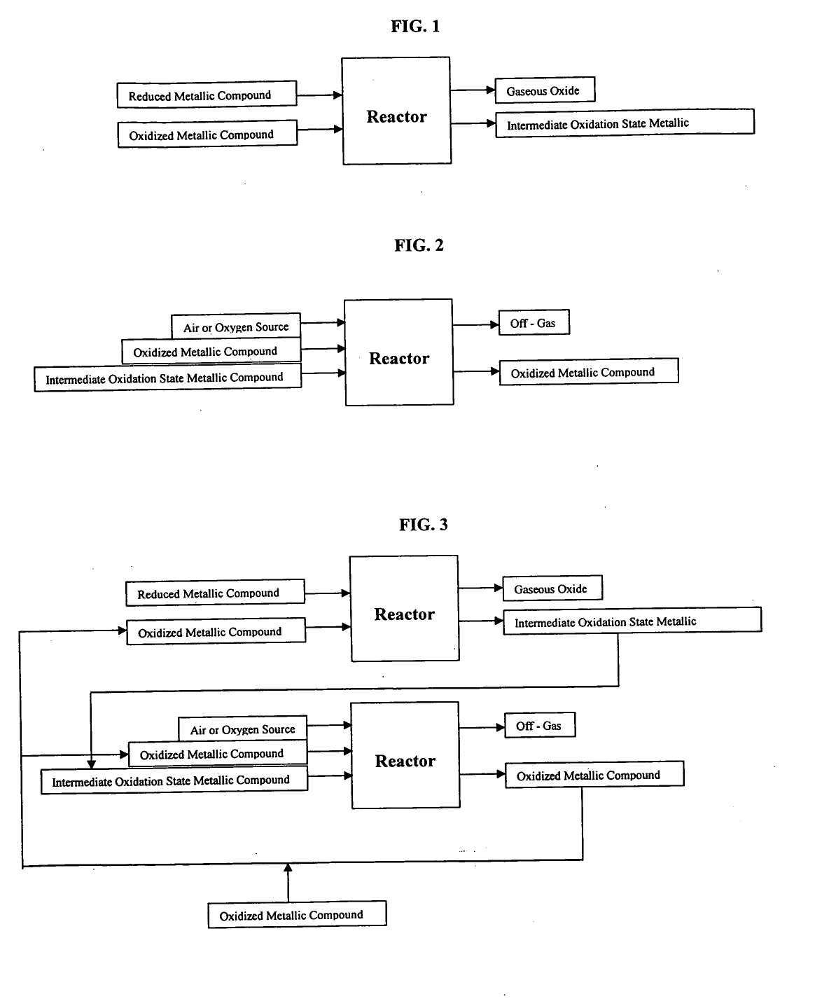

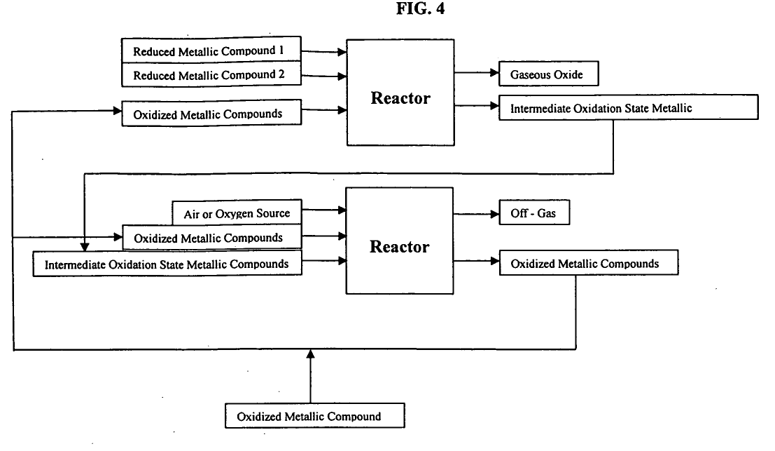

FIGS. 1 and 2 show the block diagrams of a two step process with a first step (FIG. 1) being an oxidation reaction of a metal sulfide MS_{z} conducted in a Reactor which can be a, fluidized bed, multi-hearth furnace, plug flow reactor, stationary retort, flash reactor, autoclave, cascading fluid bed, or other reactor or rotary kiln, producing a partially reduced compound or sub-oxide MO_{y} of the metal and a second step (FIG. 2) conducted in a reactor which can be any of a rotary kiln, fluidized bed or multi-hearth furnace, plug flow reactor, stationary retort, autoclave, cascading fluid bed, or other reactor in which the sub-oxide is reacted with oxygen (O₂) or other oxidizing agent in a dilute reactant system to raise the sub-oxide to a higher oxidation state under excellent temperature control. FIGS. 3 and 4 show a block diagram of a similar process with metal sulfide materials and a second metal (M2) (or a second metal sulfide, M2S₂).

The reactors of the two steps in FIGS. 1, 2 or FIGS. 3, 4 can be separate units or with substantially integrated or linked equipments (e.g. two connected segments of a rotary kiln) for better continuity of process flow and efficiencies of process control.

In the reactors the reactions of the two steps above may be conducted, generally at 500-1000° C. temperature range and at atmospheric pressure or slightly above (up to 30 psi) except that in some instances a high pressure reaction step (pressure up to 1000 psi) may be used (e.g., via autoclave oxidation or aqueous oxidation or nitric acid oxidation in aqueous environment and at about 90-300° C. range). In the first step pressure is preferably slightly above atmospheric to exclude ambient air and use the oxide from the second step as sole or primary oxidizing agent (with a controlled admission of second make-up oxidizer if needed). The second step can be conducted in a closed environment as in the first step or in air (except for the high pressure variants described above).

### NON-LIMITING EXAMPLES

### Example 1

### In Principle Example for Copper Sulfide Materials

Copper sulfide based ores (chalcocites) may be ground to 10-100 micron size range, and mixed with xanthate reagents and subjected to froth flotation to concentrate copper sulfide content, dried and then fed to a rotary kiln for reaction (1), i.e. oxidized in a reaction to produce sulfur oxide and metal sub-oxide and (2) the sub-oxide then oxidized to a higher oxidation state as follows:

(1) Cu₂S+CuO→Cu₂O+SO₂ The sulfur oxide (in gas form) is removed for conversion to sulfur, a sulfate, or other useful form.

(2) The copper sub-oxide can be transferred to a separate rotary kiln or a downhill section of the original kiln partly isolated from the first section and exposed to oxygen or air for the reaction converting from a sub-oxide to oxide;

Cu₂O+Air→CuO

CuO may be recycled as the oxidizer for step 1. The metals M, M1, M2 may be single elements or alloyed or mixed elements. The cupric oxide (CuII) produced in step (2) can be returned to the first reactor as the sole or primary oxidizer.

### Example 2

### In Principle Example for Cobalt Sulfide Materials

Another example of the process is provided for converting CoS to CoO wherein, CoS in particulate form is blended with Co₃O₄ and reacted to produce CoO and SO₂. The temperature in the reactor is maintained at a level sufficient to cause the reaction to go forward. A portion of the CoO may be removed from the reactor as a product and the remainder is further oxidized in a second reactor at a temperature sufficient to generate Co₃O₄ which is recycled to the first reactor therein to react with and convert the CoS to CoO.

These examples can be varied as set forth above as to Case A vs. Case B and as applied to other reduced metallic compounds.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

What is claimed is:

1. A looping method of for production of sulfur based oxide material and/or carbon based oxide material and/or nitrogen based oxide material from a source material selected from the group of organic and inorganic metal-containing sulfur compounds and/or carbon compounds and/or nitrogen compounds, including metal sulfide and/or sulfates and/or carbides and/or carbonates and/or nitrides and/or nitrates, comprising the steps of:
(A) oxidizing the suffurous and/or carbonaceous and/or nitrous material in a first reaction step, that yields a sub-oxide of the inorganic or organic cation or ligand of sulfur and/or carbon and/or nitrogen,
(B) further oxidizing the sub-oxide to a higher oxidation state in a second reaction step that is carried out in a dilute reactant system, and
(C) looping all or part of the higher oxidation state material back from the second step to the first step for use as an oxidizing agent, and
(D) removing materials enriched in sulfur and/or carbon values and/or nitrogen values from the first step in an oxide, sulfate or carbonate, or nitrate form for fiber processing or use.

2. The process of claim 1 wherein multiple first step type reactions and/or one or more step 2 type reactions are conducted.

3. The process of claim 1 wherein multiple second step type reactions and/or one or more step 1 type reactions are conducted.

4. The process of claim 1 wherein the first step is carried out in a reactor selected from the group consisting of a flash furnace, fluid bed, rotary kiln, multi-hearth furnaces, stationary retort, autoclave, plug flow reactor, cascading fluid bed and plasma furnace and the second step is carried out in a reactor selected from the group consisting of a flash furnace, rotary kiln, fluid bed, multi-hearth furnace, stationary retort, autoclave, plug flow reactor, cascading fluid bed and plasma furnace.

5. The process of claim 1 wherein multiple reactions greater than two are implemented, the additional oxidation reaction steps economically producing high concentration levels of additional stable sub-oxides, sulfates, carbonates, and/or nitrates.

6. The process of claim 1 wherein the starting material is selected from the group consisting of metal containing: inorganic sulfides, organic sulfides, inorganic sulfates, organic sulfates, organic sulfates, inorganic carbides, organic carbides, inorganic carbonates, organic carbonates, inorganic nitrides, organic nitrates, inorganic nitrates and organic nitrates.

7. The process of claim 6 wherein the starting material comprises one or more metal nitrides, carbides, or sulfides as a major component.

8. The process of claim 6 wherein the starting material comprises one or more metal nitrates, carbonates, or sulfates as a major component.

9. The process of claim 6 wherein the following metals are the primary metallic compound being processed: Li, Na, Mg, Al, Si, K, Ca, Ti, V, Cr, Mn, Fe, Co, Ni, Cu, Zn, Ga, Rb, Y, Zr, Nb, Mo, Ag, In, Sn, Te, La, Hf, Ta, W, Re, Pb, Bi, Th, and U.

10. The process of claim 7 wherein ammonium containing metallic compounds are oxidized in the first reaction step.

11. The process of claim 7 wherein the sub-oxide, sulfate, carbonate, and/or nitrate products produced from the single and/or multiple solid state reactions exhibits unique physical and chemical properties and are produced in high concentrations.

12. The process of claim 7 wherein mixtures of the listed metals, and complex compounds of these metal sulfides, sulfates, carbides, carbonates, nitrides, and/or nitrates and/or organic metal complexes consisting of at least two of the metallic elements listed are the primary reactant being processed.

13. Method of claim 1 as applied to removing sulfur and sulfur compounds from an inorganic sulfide rich source material comprising a first step of reacting a material containing a sulfide compound with an oxidizing agent to produce a sub-oxide of the cation of the sulfide, then further processing the thus produced sub-oxide in a second step by oxidation to a higher level and recycling such oxide to the first step, for use as the oxidizing agent therein in a substantially continuous chemical looping combustion process.

14. The method of claim 13 wherein the source material is a metal sulfide and an oxide of the same metal is used for the metal oxide oxidizing agent of the first step.

15. The method of claim 13 wherein the source material is a metal sulfide and a second metal value is included in the material or added thereto in the first step, thereby producing mixtures of metallic sub-oxides in the first step as well as well as sulfur oxide, the sub-oxides being passed to the second step.

16. The method of claim 15 wherein oxides of one or both of the two metals is recycled to the first step.

17. The method of claim 13 wherein the first step is carried out in a reactor selected from the group consisting of a flash furnace, fluid bed, rotary kiln, multi-hearth furnaces, stationary retort, autoclave, plug flow reactor, cascading fluid bed and plasma furnace.

18. The method of claim 17 wherein the second step is carried out in a reactor selected from the group consisting of a flash furnace, rotary kiln, fluid bed, multi-hearth furnace, stationary retort, autoclave, plug flow reactor, cascading fluid bed and plasma furnace.
